(19) United States
(12) Patent Application Publication
(10) Pub. No.: US 2008/0201216 A1
(43) Pub. Date: Aug. 21, 2008

(54) Target advertising to a specific user offered through an intermediary ISP, Server or Wireless Network

(76) Inventor: John Almeida, Berkeley, CA (US)

Correspondence Address: LOUIS VENTRE JR, 2483 Oakton Hills Dr., OAKTON, VA, 22124, US

(21) Appl. No.: 11/677,224

(22) Filed: Feb. 21, 2007

(51) Int. Cl. G06Q 30/00

(52) U.S. Cl. 705/14; 709/238

(57) ABSTRACT

A method for targeting advertisings to users through an ISP by supplying related content to the user visited webpage, websites, user profile, previously viewed content, user surfing history and wireless node's demography data. Furthermore, an Indexing Server working in harmony with the ISP as to provided related contents to the user and based on user's previously viewed contents, user's surfing history and user's profile. As well, a wireless node having means to provide to a user additional contents and based on the wireless node's contents choice.

### BACKGROUND OF INVENTION

1. Field of the Invention

The field of this invention relates generally to a method for targeting advertisings to users through an ISP by supplying related content to the user visited webpage, websites, user profile, previously viewed content, user surfing history and wireless node's demography data.

2. Prior Art

The prior art U.S. Pat. No. 6,339,761 assigned to Cottingham teaches a method for providing advertises to Internet Service Providers (ISP) where the ISP has precise control over who receives an advertisement. Thus, in accordance with Cottingham '761, an ISP provider may offer advertisers precision advertising, since an ISP provider has access to precise demographic data on each of the ISP's customers. Furthermore, Cottingham '761 teaches the ISP provider also having access to data on the periods of usage, including the type of customers accessing the Internet during such periods of usage and using this information to target advertisings to precise audience. It further teaches the insertion of advertisings into web pages by the ISP, or, the removal of advertisings from a webpage by the ISP and the insertion of advertisings by the ISP's advertisings.

Although Cottingham '761 teaches a method for targeting advertisings to a specific audience it fails to teach a comprehensive way of targeting advertising/contents to a specific audience without intrusions, since advertisings are inserted into pages as they traffic through the ISP and in many cases, removing advertisings that are already rendered into the webpage, this causes copyright infringements by changing the contents of webpage without any kind of consent from the content holder. Furthermore, by changing advertisings that are already rendered into a webpage causes a false sense on the user of the legitimacy of the content. Thus, Cottingham '761 leaves questions of the legality of its invention answered.

It is the object of the present invention to advantageously provides precise advertising and contents (henceforth used interchangeably) to user through Internet Service Providers (ISP's) target to specific audience and based on the relationship between the user's viewed contents and advertisings, the user's profile, the user's surfing history, wireless node's demography data and the user's previously viewed content's relationship with other contents. Furthermore, the present invention will not cause any legality issue or any false sense of content's legitimacy.

### SUMMARY OF THE INVENTION

It is the object of this invention to demonstrate a method for targeting advertisings to a user accessing an ISP by parsing the user's content data and relating content based on the words or objects similarities between the advertisings and the user's viewed webpage.

It is a further objective of this invention to target advertisings to a user based on the user's profiling data and the user's previously viewed content and user's surfing history.

Still a further objective of this invention to provide content to a user based on the wireless node's demography data by which the user is receiving data through. Yet it is a further object of this invention to allow a wireless node to render a tab, bar, menu or anything of the sort that will allow the user to view other contents based on the wireless node's demography.

Furthermore, it is the object of this invention to have contents indexed by an Indexing Server (IS) at anytime (before the contents are viewed by the user, while the user is viewing the contents or after the user views them) and the indexing server supply them to the user based on the user's interaction with the ISP, like, content relationship, previously viewed content, user's surf history, etc.

### BRIEF DESCRIPTION OF THE DRAWINGS

The accompanying drawings, which are incorporated in the form a part of this specification, illustrate embodiments of the invention and, together with the description, serve to explain the principles of the invention:

FIG. 1 illustrates a preferred embodiment of this invention in which an Indexing Server and ISP works in harmony to supply content to a user.

FIG. 2 illustrates another preferred embodiment of this invention in which an ISP supplies content to a user.

FIG. 3 illustrates one more preferred embodiment of this invention in which a wireless node will present on the web browser a means for a user to select contents based on the wireless node's preferences.

FIG. 4 illustrates client/server communication over the Internet/Network and an electronic representation of a computing device.

FIG. 5 illustrates linking means for interfacing a user to the ISP and Indexing Server.

### DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

As will be appreciated by those of skill in the art, the present invention may be embodied as a method or a computer program product. Accordingly, the present invention may take a form of an entirely software embodiment or an embodiment combining software and hardware. Furthermore, the present invention may take the form of a computer program product on a computer-readable storage medium having computer-readable program code means embodied in the medium. Any computer readable medium may be utilized including but not limited to: hard disks, CD-ROMs, optical storage devices, or magnetic devices.

Also, any reference to names of a product or of a company is for the purpose of clarifying our discussion and they are registered to their respective owners.

In a preferred embodiment the present invention provides a method for enabling an Index Server (IS) and Internet Service Provider (ISP) work in harmony or independently providing related and targeted content to a user accessing the Internet through the ISP. The targeted content can be based on the user's previously visited contents and other contents (they can be any kind of content, advertisings, video, audio, news, weather, etc.) hosted by the ISP and have them saved at the IS's database. At a later time when a user is accessing the contents through the ISP, the ISP will have means to associate user's accessed contents with contents indexed by the IS. The IS can be located at the same site as the ISP or in a separate site, separate URL (Universal Resource Locators) address. If the IS is located at a location other than the ISP's location, the IS is, or will act similar to a search engine portal, e.g. Google, Yahoo, MSN, etc.

Some or all of the contents accessed by users might be indexed at the IS server and at the time users are accessing contents through the ISP, the ISP or the IS can parse the contents and save their objects (words, links, bold, italics, titles, etc.), and they will be objects of previously viewed contents, then at a later time once a user requests additional contents from the ISP, IS, or any other server associated with the ISP, the associated server, or the ISP will provide contents and they will be based on the user's previously viewed contents objects (contents the user is viewing in the current session or a previous session), user's profile data, user's surf history, user's previously viewed content, and, if the user is accessing the ISP through a wireless node link, the wireless topographical data (wireless's address location, zip code, city, longitude and latitude locations, etc.) can be used as well. User's profiling data can be any data pertinent to the user, including but not limited to: income, sex, age, hobbies, marital status, etc., and previous viewed contents can be any content in any category, including but not limited to: video, audio, advertisings, web pages, web sites, etc.

Once a user receives a page trough an ISP, the ISP may insert some kind of link, bar, floating bar links, tabs, etc., to indicate to the user that other contents are available as well (contents based on the user's previously viewed contents objects, user's profile data, user's surf history, user's previously viewed content, etc.), and once the user clicks on them the user will be directed to the ISP, IS, or any affiliated server with the ISP, and the additional content will be provided by one or more associated locations. Any of the associated servers (e.g. IS, ISP, other servers, etc.) will be able to share any or all information regarding the user accessing the Internet through the ISP as to provide the appropriate contents to the user.

In the case a user is accessing the Internet through a wireless node or any kind of node where a user get Internet access through, the node will have means to insert (render) the aforementioned links into the webpage. Other means can be used as well, like, a program code (java applet, JavaScript, activeX, etc.) can be used to interact with the web browser, and the web browser in turn will create a means (tab, bar, links, etc.) for the purpose of enabling the user means for viewing additional related content.

In regards of the means for the user to access additional related contents, it can be a bar that a user downloads and install, the bar can be downloaded from the ISP, IS, or any other associated server to the ISP. The bar can be user-downloaded or server-supplied (ISP, IS, other server, etc.) as the user interacts with the ISP. The bar can be a commonly used bar, one of those used frequently by all brands of browsers and most of the time; the bar is static at the top part of the web browser and next, or just below the browser's navigational bar, they can be a floating bar as well without departing from the true spirit of the teachings of this invention. They can be tabs created by the web browser, like; tabs create by the Mozilla Firefox web browser.

I) Theory of Indexing Contents' Objects

A content page has objects and they are: words, words within links, words within titles, words in bolds, words in underline, words in italics, name of images, invisible objects used by the web browser but not displayable to a user at the web browser, Java Applets, activeX, audio/video players embedded to the web page, etc. An algorithm can be programmed in any conceivable way as to index these contents. One commonly used way is to count the words of a content page based on the number of time they appear therein, then set a threshold for the algorithm to choose target words for the indexation. The threshold can be set to only index words that appear n-times in the page or higher, n-times or lower, the words that appear more often, less often, etc. If a word appears more often it will be a higher-choice candidate, if it appears less often, the same can be true, as well. Words appearing in bold, italics, underline, titles, images links, links in general, they can be higher-choice candidates as well, it will depend how the algorithm's priority is set therefore.

As we proceed in explaining this invention, the indexed content can be online user-supplied contents, contents fetched from a Content Server (CS) over the Internet or contents fetched from the ISP. The IS will have means to related the objects (e.g., words, links, etc) of the online user-supplied contents (e.g. advertisings) and the fetched contents, their relationship can be but not limited to: common words, similar words, partial matching words, full matching words, synonymous words, words having similar sound, etc. The same mechanism that is available to the IS is also available to the ISP. The ISP can have means for receiving user-supplied content online, parsing, indexing and relating them with other contents that are hosted by the ISP or routed through the ISP, as well.

II) The Theory of Internet Communication

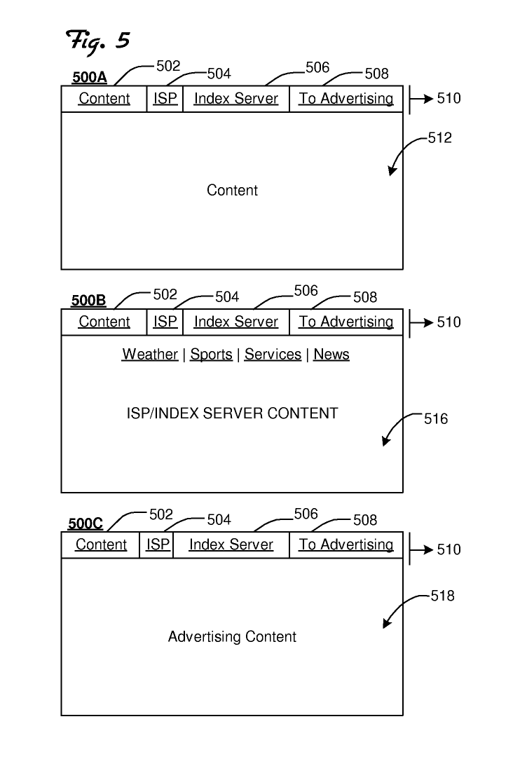

Lets turn our attention to FIG. 4 and it illustrates a server 400, the Internet 402 and an optional wireless node 404, and a client computer 406. The Internet channel 402 is the communication channel between the client 406 and the server 400. The client 406 initiates a request for contents from server 400 and it returns contents thereafter. The Internet is the transport vehicle for transporting data between the two computers. Each computer of the illustrated arrangement, the server 400, the wireless node 404 and the client computer 406, each has an electronic processing unit 450 responsible for its functionalities.

The electronic unit 450 may or may not have all the components, or may have more components than those depicted thereon. In any case each will have at least some basic electronic units like the CPU 460 and it is the brain of the device responsible for all of the device's functionalities. At power up, the CPU 460 loads instructions from ROM 454 and the instructions will instruct the CPU 460 to load an Operating System (OS) from the storage unit 464 (it can be a magnetic disc, CD ROM, etc) into RAM 452. As needed the electronic device will communicate to outside environment through its I/O port 468 and in the case of the illustrated devices, they can be a network card that allows communication using the Internet.

The CPU 460 communicate differently with each of its connected electronic unit, in some cases the communication and interaction is two-ways and in other instances, one-way. As for the illustrated device 450 the CPU 460 does a one-way communication with the ROM 454 (one-way arrow 456) unit and two-way communication with all other devices as indicated by the two-way arrows (466, 462, 458 and 470). As it is clear to those of the skill in the art, each device will have input means as well, like a mouse, keyboard, and other visual interfacing means like a screen, etc.

III) The Invention

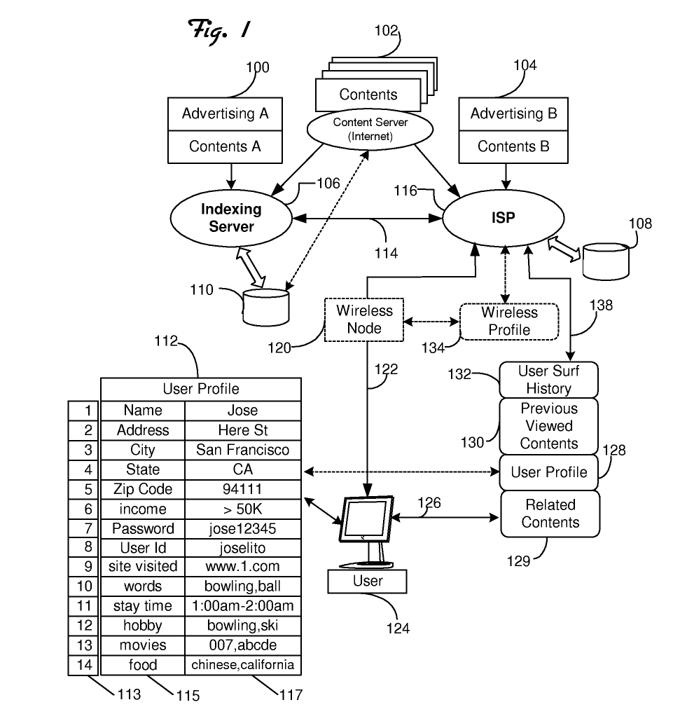

Lets move on and explain this invention, as we now turn our attention to FIG. 1, it illustrates what we've aforementioned. The Indexing Server (IS) 106, the ISP 116, Internet contents 102 common to both servers, IS 106 having its local contents 100 and the ISP 116 having its local contents 104 as well. The IS server 106 will retrieve contents 102 and index them based on the indexing rules previously mentioned, that is, the IS server will index the contents' objects and save them into its database 110. As a user interacts with the ISP server 116, it will fetch and transmits to the user the same contents (others can be transmitted as well) to the user 124. If a wireless node 120 is present the user 124 will receive contents 102 through ISP 116, wireless node 120 and the link 122. As indicated by the dotted lines, the wireless node 120 is optional, and it may or may not be present all the time. Contents 102 are hosted by other servers on the Internet and accessed by the user 124 through the ISP 116. Now, contents supplied by the IS 106 to the ISP 116 and the ISP 116 or to the user 124 can be contents that are online-user supplied (e.g. advertisings) to the IS 116, or, they can be contents 102 fetched from Content Servers (CS) over the Internet and indexed at the IS 106.

As we analyze IS 106 and ISP 116 they both are related 114 and they both can exchange information, data, contents, etc., and as the user interacts with the ISP 116, the ISP 116 may at any time save the user's interaction like, user surf history 132, or it may save the contents 102 transmitted to the user and performs the same as the IS 106, that is, index and save them. Or, the ISP 116 can send the user surf list 132 to the IS 106 and the IS 106 will fetch the contents 102 and index them for later use, if they are not yet indexed. The ISP 116 can save the user surf list 132 in its database 108 as well, or just pass them to IS 106 along with user's profiling information 112 (128) and the IS 106 will do the indexation and saving. As illustrated the user profile 112 is present on the ISP 116 but it can be present on IS 106 as well.

Lets review the user profiling information table 112. It has three columns and the 1^{st} column 113 represents the rows number for the table 112, the 2^{nd} column 115 represents the ID's for table 112 and the 3^{rd} column 117 represents the values for the ID's of column 115. For sake of simplicity, only one table is illustrated for the user, as it is well known to those skilled in the art, in the real world, table 112 most likely will be divided into more than one table. Lets move on with table 112 and it has “Name” row #1 113, “Address” row #2 113, “City” row #3 113, “State” row #4 113, “Zip Code” row #5 113 and “income” row #6 113. The just mentioned rows are for the user profile and rows #7 and #8 are for the user login credentials with ISP 116. As for rows #9-#11 they illustrate the user's interaction with ISP 116 and rows #12-#14 indicate the user's preset preferences.

As aforementioned, the wireless node 120 is optional as indicated by the dotted lines and in case it is present, its demographic data like, but not limited to: its longitude and latitude location, address, city, zip code, street, ID, site ID, etc. (134), can be used by the ISP 116 or the IS 106 for providing contents to the user 124. The contents can be any kind of content that is geographical related, like but not limited to: shops in the surrounding area, accommodations, bars, SPAS, etc. The information can be in the form of advertisings, promotions, sales, maps, etc.

The topographic information of wireless 120 and user 124 can be used in conjunction or separate, if used separate, the user's 124 profile can be used to send contents (information) to the user that are located in surrounding area of the wide are node 120 based on the similar contents located at the user 124 location (address) if the user is using a wireless node not located at the user's address (128 and 112). The content can be content-related 129 to the user's previously viewed content 130 and the contents of the wireless node's 120 location. Once again, the information (contents) can be any type and in any form as well.

Lets move forward to FIG. 5 and it illustrates three exemplary screens. The first one 500A illustrates but one way to present contents to a user accessing the ISP. Once a content page is received 500A with a “Content” displayed on content area 512, it is “Content” 102 of FIG. 1, and it is the content that the user received from the Internet through the ISP server 116. As we aforementioned, the top part of the content page 500A illustrates a bar 510 with links and having the link for the displayed “Content” 502 and it is used once the user is viewing other contents (contents associated with the other links of the bar) and needs to get back to the original content “Content” 512, link 504 will link to the ISP 116 (FIG. 1) and receive contents, and it is the content illustrated on content area 516 of 500B, link 506 will link to Index Server (IS) 106 (FIG. 1), receive contents from it, then have them displayed on display area 516 of 500B, and a link for advertisings 508 will receive advertisings, and they will be displayed on screen area 518 500C. The bar 510 can be any kind of bar, floating bar, a tabs assigned by the ISP to the web browser in the HTML (Hyper Text Markup Language) format, tabs assigned by the browser for the session, user downloaded bar, bar embedded to the web browser, etc.

As we proceed to the second exemplary screen 500B it illustrates the same bar 510 and at this time the ISP 504 or the IS 506 link was selected, since either server can provide content to the user, and the content is displayed on screen area 516 of the web page, and as depicted, they can be any kind of content. Finally, screen area 518 illustrates advertising content and it can be about shops, business, points of interests, etc., in the surrounding area where the user is accessing the ISP. The information can be related to the wireless node's data, to the user's profile, contents/advertisings related to the user's previously viewed content, user's profile, user's surf history, etc.

Any of the aforementioned embodiments and means of use of this invention can be used individually or in a group without departing from the true spirit of this invention. If these arrangements are used differently in conjunction with other arrangements that produces the same or close to the same end results, the objective of this invention is thus fulfilled. The user will have a variety of contents besides the contents accessed from the Internet through the ISP, the contents will enhance the user's experience and the contents are related to the user interests, profiling, previously viewed contents, user/wireless node demography, etc.

The user profile can include user's hobby, users preferences like, but not limited to: sports category, movie category, clothing preferences, shoes preferences, etc., and once the user is accessing the Internet through the ISP, advertisings and other contents will be available to the user. Lets say that the user is in a specific location and it has a sports shop having a special sale on bowling shoes and the user's hobby preference happen to be bowling, once the user is viewing the contents from the ISP and the ISP's uses the user's profiling and the wireless node's data (if the user is accessing the ISP through the wireless node), then the bowling advertisings can be correlated to the user, since the user is in the surrounding area. The same is true regarding previously viewed contents, if the user has in the past, or in the current session, viewed a content page/website for bowling equipment or information of the like, the advertising will be targeted to the user as well. Also, once the user is accessing the ISP, the ISP can track for how long the user stays at each page or at each website and correlated this information with other data pertaining to the user as well, FIG. 1 table 112 rows #9-#11.

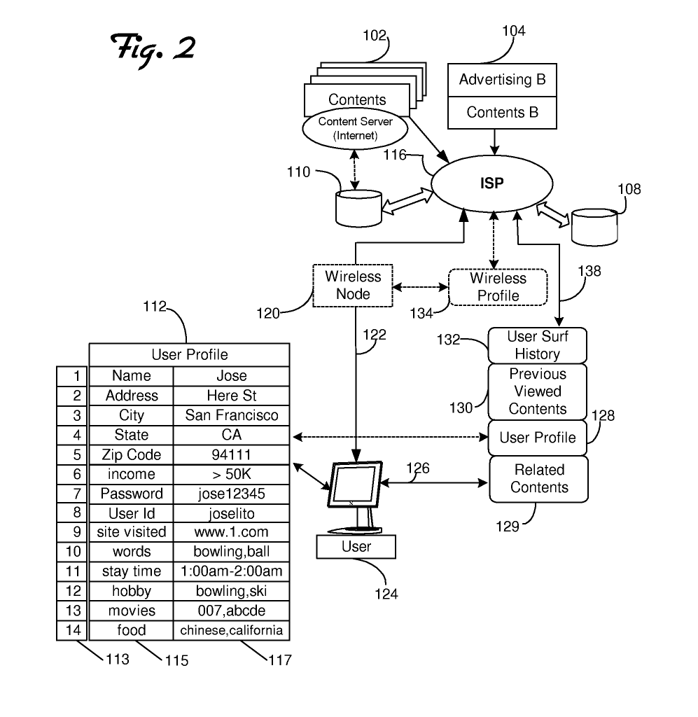

Lets turn our attention to FIG. 2 and it illustrates one more embodiment of this invention, it illustrates the same arrangement of FIG. 1, and all the drawing's element numbering are the same for both drawings as well, except for the database 110, at FIG. 1 it was attached to the IS 106 and now it is attached to ISP 116 and it indicates that the ISP 116 will do all the contents' 102 indexing and at FIG. 1 it was done by IS 106. The difference between the arrangements of FIG. 1 and of FIG. 2 is that the IS 106 had the ability to do the content's 102 indexing before they were requested by a user and served to the user by the ISP 116. In this arrangement, in most situations, the indexing will be done as the contents are requested, although, they can be indexed prior to a user's request as well. The remaining elements of the arrangement of FIG. 2 will not be explained since they have been fully explained whence the FIG. 1 was reviewed and anyone with the skill of the art will be able to follow the explanations given and understand its meanings as well.

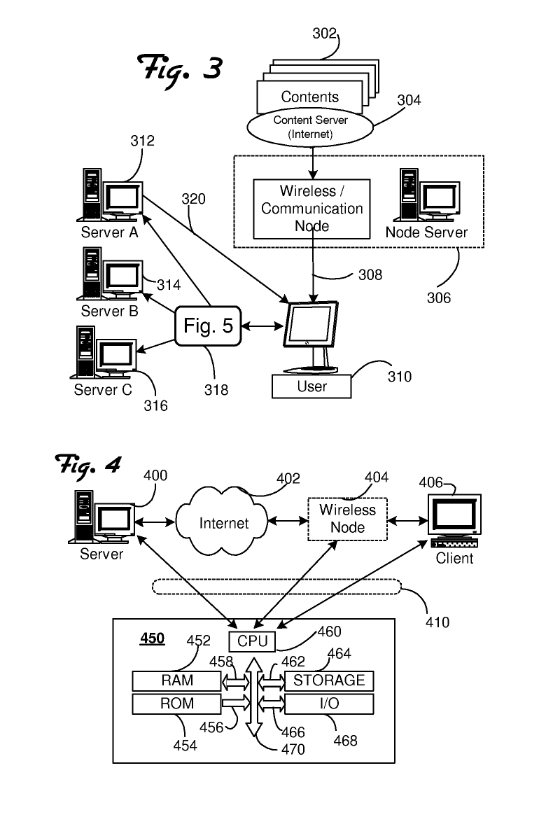

There are many ways to implement this invention and the more we review its functionalities, the more modes of uses become apparent and its tremendous potential will be appreciated by those of the skill in the art. As we turn now to FIG. 3 and it illustrates but one more embodiment, and this time, contents 302 transmitted to the user 310 through wireless node 306 connections 304 and 308. Others elements like an ISP server has been left out and it is apparent to those of the skill in the art that some kind of server will be supplying the contents 302 to the user 310 through wireless/communication node (hence forth called node) 306.

As we've discussed for FIG. 1 and FIG. 2, we've said that the ISP server had means for supplying contents to the user and it was illustrated on FIG. 5. And the user interacted with the related contents by selecting links in some kind of bar, tabs, floating bar, browser bar, etc. As illustrated in FIG. 3, the same can be accomplished as well, by having the node to perform the same tasks that was performed by the ISP, now, the node can have a computer attached to it as well, and the computer will act as an intermediary between the user 310, the node 306 (can part of the node or separated from it) and contents 302, it will do all the parsing of contents and the parsed information, as needed, can be saved therein.

The computer associated with node 306 will do all the functionalities that before were performed by the ISP in the aforementioned arrangements. Once links of FIG. 5 518 are clicked by a user, the user can be directed to one or more servers (312, 314 and 316) and information about the user visited contents, node's data and the user's preferences, etc., may be sent to the server(s), and one or more servers will be able to supply addition contents 320 directly to the user 310, or, through the node's server 306. The illustrated computer associated with the node 306 can be incorporated inside the node's electronic unit as well, without departing from the true spirit and teachings of this invention. As it is understood to those of the skill in the art, a communication node can be any kind of a node between two computers, it can be a modem, a wireless node, a local area network, etc.

### CONCLUSION

A method for targeting advertisings to users through an ISP by supplying related content to the user visited webpage, websites, user profile, previously viewed content, user surfing history and wireless node's demography data. Furthermore, an Indexing Server working in harmony with the ISP as to provided related contents to the user and based on user's previously viewed contents, user's surfing history and user's profile. As well, a wireless node working alone or in harmony with other server and having means to provide to a user additional contents and based on the wireless node's contents choice.

Although the present invention and its advantages have been described in detail, it should be understood that various changes, substitutions and alterations could be made herein without departing from the true spirit and scope of the invention as defined by the appended claims. Moreover, the scope of the present application is not intended to be limited to the particular embodiments of the process, machine, manufacture, composition of matter, means, methods, computer software and steps described in the specification. As one of ordinary skill in the art will readily appreciate from the disclosure of the present invention, processes, machines, manufacture, compositions of matter, means, methods, computer software, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, computer software or steps.

What is claimed is:

1. A method of user-related content, comprising:
a Indexing Server (IS);
a Internet Service Provider (ISP);
at least one user;
at least one computer, said at least one computer connected with said at least one ISP through a communication node;
said at least one user is at said at least one computer;
at least one Content Server (CS), said CS hosting at least a first content;
said ISP and said IS having a relationship, said relationship will enable said IS and said ISP to exchange data;
said IS further comprising:
means to retrieve said at least first content hosted by said at least one CS;
said at least first content retrieved by said IS from said CS having a plurality of objects;
said IS having means to parse said plurality of objects of said at least first content that was retrieved from said CS as a first set of objects;
said IS having means to store said first set of objects in an electronic index/search format;
means for accepting at least a second user-supplied content online;
means for parsing said at least second online user-supplied content's objects and means to store them in an electronic index/search format as a second set of objects; and
said at least one user at said at least one computer initiates a request for said at least first content hosted by said at least one CS, said requested content is routed through said ISP, said ISP requests and receives said at least first content hosted by said at least one CS and transmits said received at least first content from said CS to said at least one user at said at least one computer connected with said ISP.

2. The method of user-related content according to claim 1, further comprising:
said at least second user-supplied content having a relationship with said at least first content hosted by said at least one CS, wherein said relationship is at least one word-object common to at least a first object of said first set of objects and at least a second object of said at least second set of objects.

3. The relationship according to claim 2 wherein said relationship is at least one word-object having a partial match between at least one word-object of said first set of objects and at least a second word-object of said at least second set of objects.

4. The relationship according to claim 2 wherein said relationship is at least one word-object having a synonymous meaning between at least a first word-object of said at least first set of objects and at least a second word-object of said second set of objects.

5. The relationship according to claim 2 wherein said relationship is at least one word having a similar sound between at least a first object of said first set of objects and at least a second object of said second set of object.

6. The method of user-related content according to claim 1, further comprising:
said ISP having means to save a user profile data, said at least one user's profile data is saved therein; and
said ISP having means to supply a link to said at least one computer and once said at least one user at said at least one computer activate said link at least a portion of a content supplied through said ISP and having a relationship with said least one user's profiling data will be displayed by said at least one computer for said at least one user therein.

7. The method of user-related content according to claim 1, further comprising:
said ISP having means to save a user previously viewed content, at least one previously viewed content by said at least one user is saved therein; and
said ISP having means to supply a link to said at least one computer and once said at least one user at said at least one computer activate said link at least a portion of a content supplied through said ISP and having a relationship with said at least one user's previously viewed content will be displayed by said at least one computer for said at least one user therein.

8. The method of user-related content according to claim 1, further comprising:
said ISP having means to save a user preset preferences data, said at least one user's preset preferences data is saved therein; and
said ISP having means to supply a link to said at least one computer and once said at least one user at said at least one computer activate said link at least a portion of a content supplied through said ISP and having a relationship with said at least one user's preset preference data will be displayed by said at least one computer for said at least one user therein.

9. The method of user-related content according to claim 1, further comprising:
wherein said communication node is a wireless node;
said ISP having means to target a content to a user accessing said ISP through a wireless node and based on the wireless node's data;
said ISP having means to supply a link to said at least one computer and once said at least one user at said at least one computer activate said link at least a portion of a content supplied through said ISP and having a relationship with said wireless node's data will be displayed by said at least one computer for said at least one user therein.

10. A method of user-related content, comprising:
a Internet Service Provider (ISP);
at least one user;
at least a first computer, said at least first computer connected with said ISP through a communication node;
said at least one user is at said at least first computer;
said ISP having means to parse contents as they traffic through said ISP;
said ISP hosting at least a first content, said at least first content having a first set of plurality of objects;
said first set of plurality of objects is stored at said ISP in an electronic index/search format;
at least a second computer, said at least second computer hosting at least a second content;
said at least one user at said at least first computer initiates a request for said as least second content from said at least second computer and said request is routed through said ISP;
said ISP receives said at least second content from said at least second computer, parses said received at least second content's objects, then saves them in index/search electronic format as a second set of plurality of objects;
at least one object of said plurality of objects of said first set of objects having a relationship with at least one object of said plurality of objects of said second set of objects, wherein said relationship is at least one common word-object from said plurality of objects of said first set of objects and said plurality of objects of said second set of objects; and
said ISP having means to supply at least one link to be used by said at least one user at said first computer and once said at least one link is activated by said at least one user at said at least first computer said at least first computer will request and receive at least a portion said at least first content hosted by said ISP.

11. The relationship according to claim 10 wherein said relationship is at least one word-object having a partial match between at least a first word-object of said at least first set of objects and at least a second word-object of said at least second set of objects.

12. The relationship according to claim 10 wherein said relationship is at least one word-object having a synonymous meaning between at least a first word-object of said at least first set of objects and at least a second word-object of said at least said second set of objects.

13. The relationship according to claim 10 wherein said relationship is at least one word-object having a similar sound between at least a first word-object of said at least first set of objects and at least a second word-object of said at least second set of objects.

14. The method of user-related content according to claim 10, further comprising:
said ISP having means to save a user profile data, said at least one user's profile data is saved therein; and
said ISP having means to supply a link to said at least first computer and once said at least one user at said at least first computer activate said link at least a portion of a content supplied by said ISP and having a relationship with said least one user's profiling data will be displayed by said at least first computer for said at least one user therein.

15. The method of user-related content according to claim 10, further comprising:
said ISP having means to save a user previously viewed content, at least one previously viewed content by said at least one user is saved therein; and
said ISP having means to supply a link to said at least first computer and once said at least one user at said at least first computer activate said link at least a portion of a content supplied by said ISP and having a relationship with said at least one user's previously viewed content will be displayed by said at least first computer for said at least one user therein.

16. The method of user-related content according to claim 10, further comprising:
said ISP having means to save a user preset preferences data, said at least one user's preset preferences data is saved therein; and
said ISP having means to supply a link to said at least first computer and once said at least one user at said at least first computer activate said link at least a portion of a content supplied by said ISP and having a relationship with said least one user's preset preference data will be displayed by said at least first computer for said at least one user therein.

17. The method of user-related content according to claim 10, further comprising:
wherein said communication node is a wireless node;
said ISP having means to target a content to a user accessing said ISP through a wireless node and based on the wireless node's data; and
said ISP having means to supply a link to said at least first computer and once said at least one user at said at least first computer activate said link at least a portion of a content supplied by said ISP and having a relationship with said wireless node's data will be displayed by said at least first computer for said at least one user therein.

18. A method a communication node to supply contents, comprising:
a communication node;
at least a first computer associated with said communication node;
at least a second computer, said at least second computer hosting at least a first content;
at least a third computer, said at least third computer hosting at least a second content;
at least a forth computer, said at least forth computer having means to request and receive contents from a computer through said communication node;
at least one user, said at least one user is at said at least forth computer;
said at least one user at said at least forth computer initiates a request for said at least first content hosted by said at least second computer;
said forth computer uses said means to request and receive contents, requests and receives said at least first content from said at least second computer; and
as said at least first content is routed through said communication node said at least first computer associated with said communication node supplies at least one link and once said at least one link is activated by said at least one user at said forth computer, said at least forth computer uses said means to request and receives contents from a computer, requests, receives and displays at least a portion of said at least second content hosted by said at least third computer.

19. The method a communication node to supply contents according to claim 18 wherein said at least first content from said at least second computer is targeted to said at least one user at said forth computer based on said communication node demographics data.

20. The method a communication node to supply contents according to claim 18 wherein said at least second content hosted by said at least third computer is targeted to said at least one user at said forth computer based on said communication node demographics data.

21. The method a communication node to supply contents according to claim 18 wherein said communication node is a wireless node.
